(19) United States
(12) Patent Application Publication
(10) Pub. No.: US 2024/0208666 A1
(43) Pub. Date: Jun. 27, 2024

(54) AVIONICS DEVICE FOR ASSISTING THE CONTROL OF AT LEAST ONE AUTOMATED AIRCRAFT SYSTEM

(71) Applicant: THALES, COURBEVOIE (FR)

(72) Inventors: Yannick LE ROUX, MERIGNAC (FR); Jean-Marc LACOSTE, MERIGNAC (FR)

(21) Appl. No.: 17/914,116

(22) PCT Filed: Mar. 22, 2021
(86) PCT No.: PCT/EP2021/057272

§ 371 Date: Sep. 23, 2022

(30) Foreign Application Priority Data
Mar. 24, 2020 (FR) FR20 02845

(51) Int. Cl. B64D 45/00; G01C 23/00

(52) U.S. Cl. CPC B64D 45/00; G01C 23/00

(57) ABSTRACT

Disclosed is an avionics device for assisting in the control of at least one automated system of an aircraft, the device being able to connect, via a network, to the at least one automated system and to a plurality of distinct sources of the automated system. The device is configured for: collecting avionics data supplied by the plurality of sources and supplied by the at least one automated system; classifying and analyzing the collected data as a function of each predetermined property to be restored to the at least one automated system; and determining, from the classified and analyzed data and from a current state of the aircraft, whether an avionics setpoint, manually entered into the device, can be attained by the at least one automated system.

### CROSS-REFERENCE TO RELATED APPLICATIONS

This application is the U.S. national phase of International Application No. PCT/EP2021/057272 filed Mar. 22, 2021 which designated the U.S. and claims priority to FR 20 02845 Patent Application No. filed Mar. 24, 2020, the entire contents of each of which are hereby incorporated by reference.

### FIELD

The present invention relates to an avionics device for assisting the control of at least one automated aircraft system.

The present invention also relates to an aircraft.

The present invention also relates to a method for assisting the control of at least one automated aircraft system.

The present invention also relates to a computer program including software instructions which, when executed by a computer, implement such a method for assisting in the control of at least one aircraft automated system.

### BACKGROUND

The present invention relates to the control of one or more automated aircraft systems. By automated system, is understood especially, in the following, an automated system or even an automatic system corresponding to a state machine or even an automaton the action of which has direct consequences on the behavior of the aircraft, such as an autopilot, a flight management system or FMS, a monitoring and/or understanding of the current flight situation such as an avionics Terrain Awareness and Warning System or Helicopter Awareness & Warning System (TAWS or HTAWS), a meteorological radar, an avionics equipment management system such as: hydraulic equipment, electrical avionics equipment, dedicated fuel equipment, de-icing equipment, pressurization equipment, flight controls configured to automatically control avionics such as wing surface management equipment to control slats, flaps, aircraft gear, etc.

Currently, the automated systems are equipped with a human machine interface, to allow them to be controlled, corresponding to control stations comprising, especially, pushbutton or rotary control switches and alphanumeric displays.

By means of this interface, a crew member, corresponding, for example, to a pilot, enters the setpoints to be followed by the automated system.

For example, when the automated system corresponds to an autopilot, the pilot sets the speed, heading, altitude and climb gradient setpoints, then engages the modes for following these setpoints or engages the operating modes managed by another dedicated automated system such as the flight management system. By mode, is understood, a state or a set of indissociable states (that is, forming only one) of the considered automated system.

Thus, the autopilot is a particular automated system because of its criticality relative to the behavior of the aircraft, its upstream links with other complex automated systems (that is, automation) the outputs of which feed it, and due to the existence of multiple axes of control by the pilot.

In addition, the current human machine interfaces of automated aircraft systems generally comprise a selection button allowing the selection of a unit of value for the setpoints. Such selection unfortunately proves to be a source of error in understanding and anticipating the behavior of the automated system with sometimes unfortunate consequences for the safety of the aircraft and its passengers.

The patent application US 2017/291691 A1 relates especially to an assistance method for aiding the navigation of an aircraft with restriction, via a control limiter, of the possibilities of adjusting the flight parameters as a function of the context, and a corresponding device. In other words, the aims of US 2017/291691 A1 are adapting/restricting, upstream of setpoint inputs by a pilot, the range of selectable setpoints as a function of the current flight context and a capability approach.

However, current human machine interfaces of automated systems, especially the interface described in patent application US 2017/291691 A1, do not allow for upstream explanation of the result of a pilot selection, much less of what is implied by the activation of a mode managed by another dedicated automated system.

Such an absence of explanation in real time is currently compensated for by the crew who are trained to know beforehand the operating algorithms of the automated system in order to anticipate the activation of a setpoint or an operating mode and to confirm the concordance of the expected and the observed.

### SUMMARY

The object of the invention is then to propose an avionics device and a related method which allow the control of an aircraft automated system to be improved by relieving the load of the crew.

To this end, the invention has as its object an avionics device for assisting the control of at least one automated aircraft system, the device being connectable, via an avionics network, to the said at least one automated system and to a plurality of avionics sources, and/or via a non-avionics network to a plurality of non-avionic sources, distinct from the automated system, said device being configured to:
collect avionics and/or non-avionics data provided by the plurality of sources and provided by said at least one automated system,
classify and analyze the collected data as a function of each predetermined property to be restored by said at least one automated system
determine, from the classified and analyzed data and from a current state of the aircraft, whether an avionics setpoint manually entered into said device can be attained by means of said at least one automated system.

The avionics device for assisting the control of at least one automated aircraft system is then able to take into account avionics and/or non-avionics sources of information external to the automated system in order to automatically evaluate whether or not a setpoint entered manually within said device and intended for the automated system can be attained or not in the current flight context, and to do so as a function of the classified and analyzed data as a function of predetermined properties to be restored to the automated system in question, and previously originating from sources distinct from the automated system in question.

Thus, the present invention aims, downstream of the input of a setpoint by a pilot, to determine whether, after entering this setpoint this remains attainable or not, and not upstream as disclosed in document US 2017/291691 A1 to adapt/restrict, upstream of the input of a setpoint by a pilot, the range of setpoints able to be selected as a function of the current flight context.

In other words, the present invention facilitates decision-making and control over any automated system the action of which has direct consequences on the behavior of the aircraft.

According to other advantageous aspects of the invention, the avionics device for assisting in the control of at least one automated aircraft system comprises one or more of the following features, taken alone or in any technically possible combination:
the device is configured to:
classify and analyze the collected data by transforming at least one collected data into a standardized (that is, universal) data independent of the type of said at least one automated system or the type of source, and/or
transform a manually entered setpoint within said device into at least one order adapted to the type of said at least one automated system;
the device is further configured to:
provide a crew member with an indication representing the possibility or not of attaining the setpoint and/or,
in the presence of an attainable setpoint, determine and provide the crew member with at least one instruction to attain the setpoint, said at least one instruction to be transmitted to the automated system;
the device is configured to build and display a universal user interface matrix, independent of the type of said at least one automated system or of the type of source, the user interface matrix comprising at least two lines and at least as many columns as predetermined properties to be restored from said at least one automated system,
said at least two lines being respectively dedicated to the display by property:
of at least one target setpoint being currently executed by the automated system of the aircraft,
of at least one next setpoint manually entered for execution from the current state of the aircraft;
the device is configured to display the target setpoint using two distinct indicators related respectively to a state of acquisition and maintenance of the target setpoint by the automated system, and to a state of progress of the aircraft, via the automated system, towards the target setpoint;
the device is configured to display the line dedicated to the display of said at least one target setpoint being currently executed by the automated system of the aircraft, at the center of the user interface matrix and/or with a dedicated color and distinct from the display color of the other lines of the user interface matrix;
the user interface matrix further comprises at least one additional line dedicated to the display, by property, of at least one conceivable alternative setpoint able/unable to be activated, to the target setpoint being currently executed to attain/maintain a same target state of the aircraft,
and/or in which the line dedicated to the display, by property, of at least one next setpoint manually entered for execution from the current state of the aircraft comprising at least one field dedicated to the display of at least one pre-selection setpoint able/unable to be activated, from the current state of the aircraft and the classified and analyzed data, and/or in which the user interface matrix further comprises at least one additional line dedicated to the display by property of at least one next setpoint, to be activated, and suggested automatically to said crew member by said device;
from the current state of the aircraft and the classified and analyzed data, the device is further configured to determine and display, by property, in the line or lines dedicated to the display of said at least one next setpoint, a result prediction related to said next setpoint and/or an information representative of a reason for activating/deactivating said next setpoint;
from the current state of the aircraft and the classified and analyzed data, the device is further configured to determine and display, by property:
a list of respectively related setpoint measurement units, and/or
at least one setpoint limit value in the line dedicated to the display by property of said at least one next setpoint manually entered for execution from the current state of the aircraft.

The invention also has as object an aircraft comprising at least one automated system, the aircraft further comprising an avionics device for assisting in the control of said at least one automated system as previously described.

The invention also has as object a method for assisting the control of the at least one automated aircraft system, said method being implemented by a device for assisting the control of at least one automated aircraft system, the device being connectable, via an avionics network, to said at least one automated system and to a plurality of avionics sources, and/or via a non-avionics network to a plurality of non-avionics sources, distinct from the automated system,
the method comprising the following steps:
collecting the avionics and/or non-avionics data provided by the plurality of sources and provided by said at least one automated system,
classifying and analyzing the collected data according to each predetermined property to be restored by said at least one automated system
determining, from the classified and analyzed data and from a current state of the aircraft, the chances of attaining an avionics setpoint by means of said at least one automated system.

The invention also has as object a computer program including software instructions which, when executed by a computer, implement a method for assisting the control of at least one aircraft automated system as defined above.

### BRIEF DESCRIPTION OF THE DRAWINGS

These features and advantages of the invention will become clearer upon reading the following description, given only as a non-limiting example, and made with reference to the appended drawings, on which:

FIG. 1 is a schematic representation of an avionics device for assisting in the control of at least one automated aircraft system according to the present invention;

FIG. 2 illustrates the interactions between the control assistance avionics device, a plurality of aircraft automated systems, a plurality of contributors, and the aircraft crew.

FIGS. 3 and 4 illustrate different parts and variants of an example of a universal user interface matrix according to the present invention related to a given automated system corresponding to an autopilot,

FIGS. 5 to 7 illustrate different examples of exchanges that can be implemented by the control assistance avionics device according to the present invention.

### DETAILED DESCRIPTION

Hereinafter, “aircraft” is understood to mean a mobile vehicle piloted by a pilot and capable of flying especially in the atmosphere of the earth or extraterrestrial atmosphere, such as an airplane, a helicopter, a space vehicle, etc.

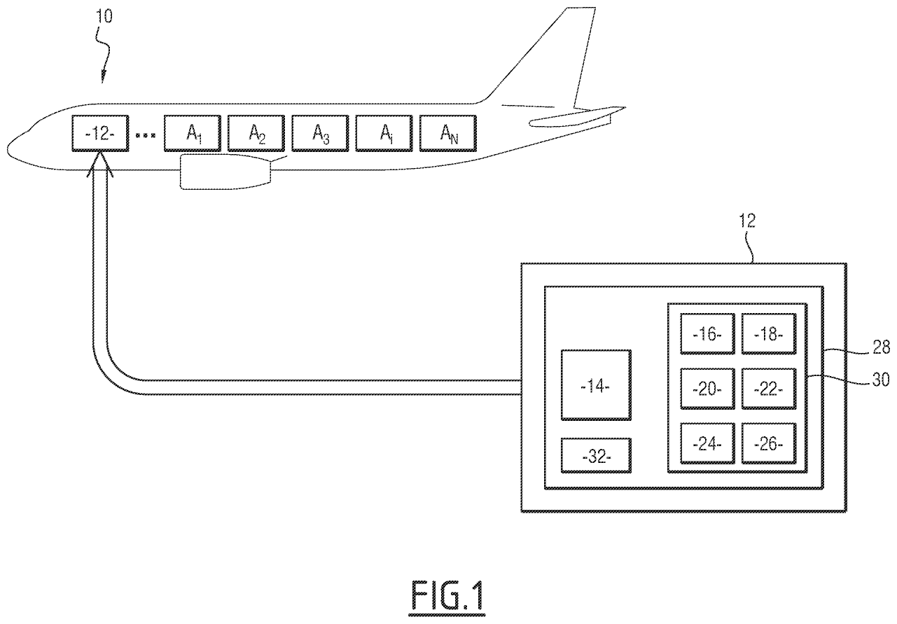

In the example of the embodiment of FIG. 1, the aircraft 10 is, for example, an aircraft capable of being operated by at least one pilot.

In FIG. 1, the aircraft 10 comprises a plurality of N automated systems A₁, A₂, A₃, . . . , Aᵢ, . . . A_{N} with N integer. For example, A₁ is an autopilot, A₂ is a flight management system (FMS), A3 is an avionics equipment management system such as: hydraulic equipment, electrical avionics equipment, fuel equipment, de-icing equipment, pressurization equipment, flight controls configured to automatically control avionics components such as wing surface management equipment to control slats, flaps, aircraft landing gear etc., Aᵢ corresponds to a monitoring and/or awareness system of the current flight situation such as an avionics Terrain Awareness and Warning System (TAWS or HTAWS), or AN corresponding to a meteorological radar.

According to the present invention, the aircraft 10 further comprises an avionics device 12 for assisting in the control of at least one of the automated systems A₁, A₂, A₃, . . . , Aᵢ, . . . A_{N} of the aircraft 10, the device 12 being connectable, by means of, an avionics network, to said at least one automated system and to a plurality of avionics sources, not shown, and/or via a non-avionics network to a plurality of non-avionics sources, distinct from the considered automated system.

According to an alternative aspect, not shown, the device 12 is disembarked from the aircraft 10 and/or related to one or more disembarked automated systems, for example on the ground, and able to transmit critical commands to the aircraft.

Such an avionics device 12 for assisting in the control of at least one of the automated systems A₁, A₂, A₃, . . . , Aᵢ, . . . A_{N} comprises, with respect to the example of FIG. 1, a first collection module 14 configured to collect avionics and/or non-avionics data provided by the plurality of sources and provided by said at least one automated system, for example A₁. In other words, such a collection module 14 is a module for receiving and storing avionics and/or non-avionics data provided by the plurality of sources and provided by said at least one automated system, for example A₁.

The device 12 further comprises a second module 16 configured to classify and analyze the collected data as a function of each predetermined “operational” property to be restored and controlled of said at least one automated system considered, for example A₁.

For example, for the automated system A₁ corresponding to an autopilot, the second module 16 is configured to classify and analyze the data collected by the collection module 14 as a function of the operational properties corresponding to at least three axes of movement of the aircraft corresponding to a vertical axis, a lateral axis and a longitudinal speed axis.

According to another example, the A₃ system is understood to be for managing avionics equipment such as: hydraulic equipment, electrical avionics equipment, equipment dedicated to fuel, de-icing equipment, pressurization equipment, flight controls configured to automatically control avionics components such as wing surface management equipment to control slats, flaps, and aircraft landing gear.

For such an A₃ automated system, the operational properties to be restored and controlled are:
the volume of fuel in the tanks for the equipment dedicated to fuel, the related manual control actions being the isolation of the tanks and/or the emptying of these tanks, the role of the equipment dedicated to fuel being to ensure the balancing of the tanks throughout the flight,
the de-icing equipment modes (in other words, on or off) for the de-icing equipment, the related manual control action being the forced manual activation of the de-icing, the role of the de-icing equipment being, in the presence of icing conditions on the wings and on the engines, to activate the heating systems,
the state of the wings for the wing surface management equipment to manage the automatic extension and retraction of the slats, flaps and landing gear of the aircraft, the related manual control actions being the immediate extension and retraction, or the modification of the extension and retraction speeds, the role of the wing surface management equipment being to extend or retract the slats as a function of the phase of flight and of the airspeed of the aircraft

The device 12 further comprises a third module 18 configured to determine, from the classified and analyzed data and from a current state of the aircraft, whether an avionics setpoint, manually entered within said device, can be attained by means of said at least one automated system.

Such a classification and analysis, of the collected avionics and/or non-avionics data, as a function of each property to be restored from the automated system, and such a determination, from the classified and analyzed data and also from a current state of the aircraft, of whether an avionics setpoint, manually entered within said device 12, is attainable by means of said at least one automated system, is neither disclosed nor suggested by US 2017/291691 A1, which does not seek, downstream of the setpoint entered by a pilot, to determine whether after this input, this setpoint remains attainable or not, but only seeks to adapt/restrict, upstream of the setpoint entered by a pilot, the range of selectable setpoints as a function of the current flight context.

As an optional complement, the device 12 further comprises a complementary abstraction module 20 configured to classify and analyze the collected data by transforming at least one collected data into a standardized (that is, universal) data independent of the type of said at least one automated system or of the type of source, and/or configured to transform a setpoint manually entered within said device into at least one order adapted to the type of said at least one automated system.

By “type” is meant especially the model of automated system used, for example, different models of aircraft, which moreover are from different manufacturers, respectively use autopilots of different types from one aircraft to another.

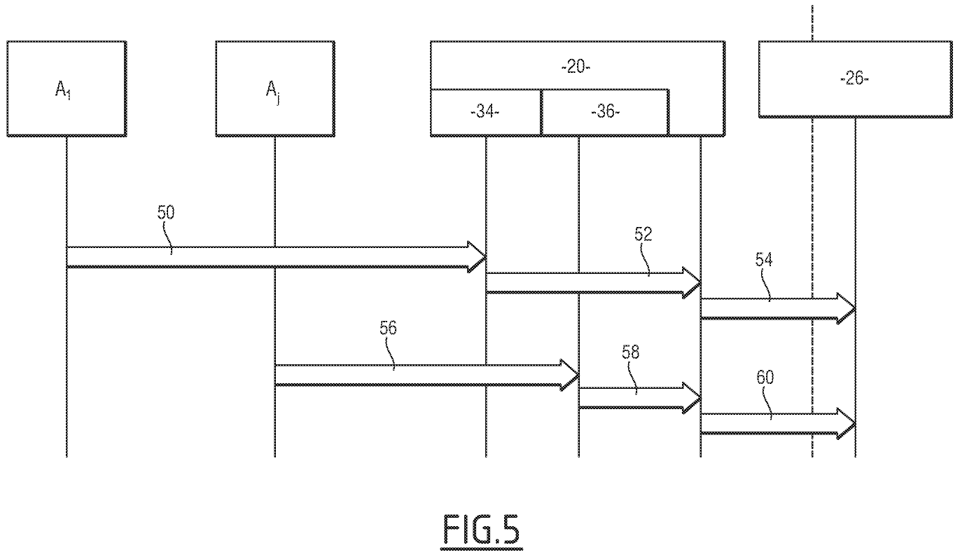

In other words, such an abstraction module 20 is able to operate the connection of the multiple inputs and outputs of any aircraft automated system without the inherent complexity of the considered automated system as detailed hereafter in relation to FIGS. 5 to 7.

As an optional addition, the device 12 further comprises a complementary module 22 configured to provide a crew member with an indication representative of whether the setpoint can be attained or not, and/or, in the presence of an attainable setpoint, configured to determine and provide the crew member with at least one instruction to attain the setpoint, said at least one instruction to be transmitted to the automated system.

In other words, the attainment instruction (or even suggestion) directly indicates to the pilot what he should do in view of the navigation context to attain the setpoint manually entered within said device via the automated system. Thus, the present invention aims at collecting a set of avionics or non-avionics data in order to propose an anticipatory, complementary or substitute setpoint suggestion in order to put the device (that is, the aircraft) in a state compatible with the attainment of the setpoint previously entered by the pilot.

In particular, the module 22 is configured to provide a crew member with an indication showing the possible or impossible attainment of the setpoint by display and optionally by audio feedback.

According to a particular aspect, the device 12 further comprises a complementary module 24 configured to build a universal user interface matrix, independent of the type of said at least one automated system or the type of source, the user interface matrix comprising at least two lines and at least as many columns as predetermined properties to be restored from said at least one automated system, said at least two lines being respectively dedicated to displaying by property:
of at least one target setpoint being currently executed by the automated aircraft system,
at least one next setpoint manually entered for execution from the current state of the aircraft.

Specifically, a “target setpoint” is related to a first state of the aircraft 10 to be attained or maintained, while a “next setpoint” is linked to a second state of the aircraft to be attained after the first state.

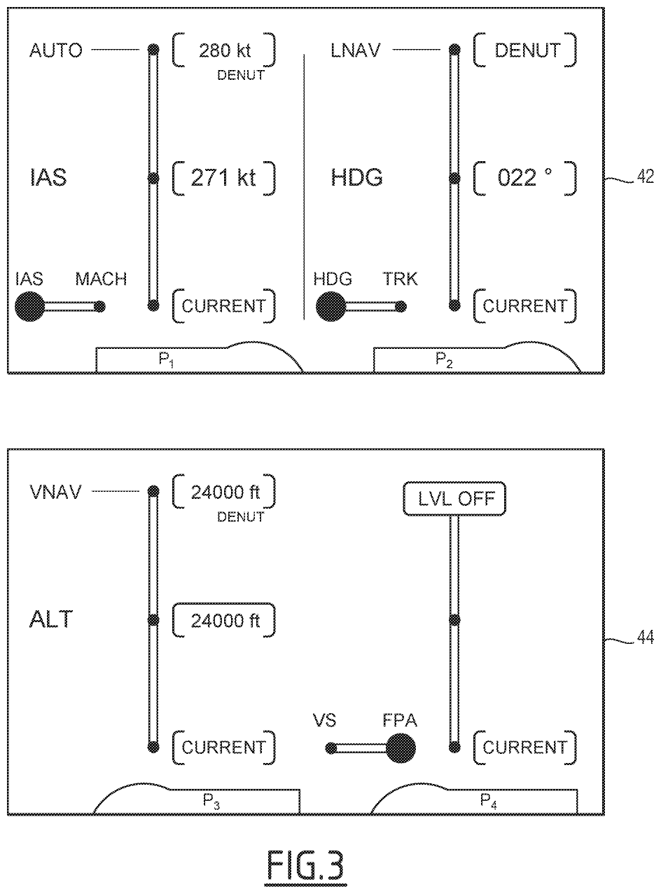

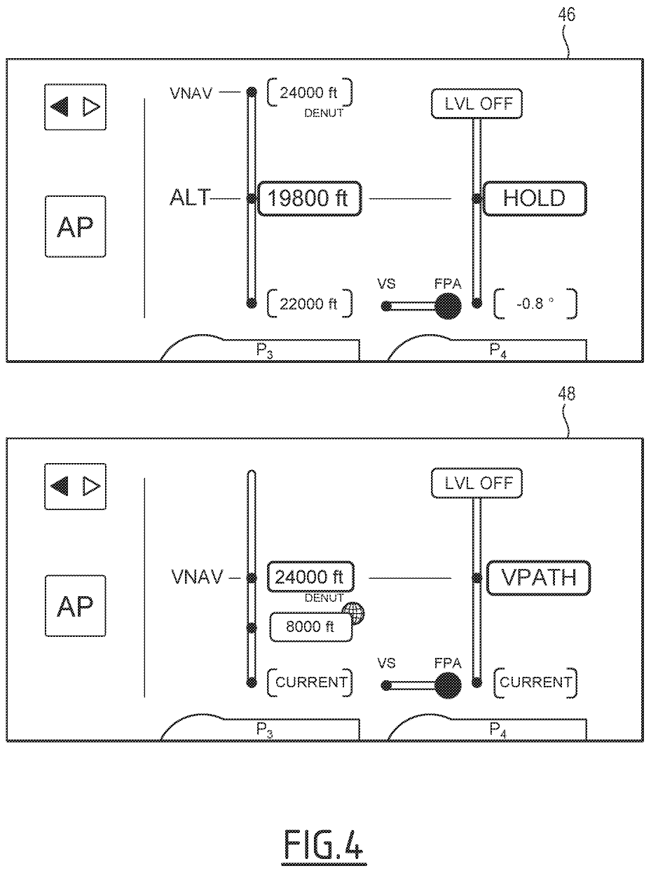

In addition, the device 12 further comprises a complementary module 26 able to configure the display of such a matrix as detailed later with respect to FIGS. 3 and 4 on a display screen, not shown, of the device 12.

According to a first option, such a complementary module 26 is furthermore able to configure the display of the target setpoint using two distinct indicators related respectively to a state of acquisition and maintenance of the target setpoint by the automated system, and to a state of progress of the aircraft, via the automated system, towards the target setpoint.

According to a second option in addition to, or independent of, the aforementioned first option, such a complementary module 26 is furthermore able to configure the display of the line dedicated to the display of said at least one target setpoint being currently executed by the automated system of the aircraft 10, in the center of the user interface matrix and/or with a dedicated color, for example pink, and distinct from the display color of the other lines of the user interface matrix.

According to a third option in addition to, or independent of, the two previous options, the complementary module 24 for building the matrix is furthermore able to build the user interface matrix so that it furthermore comprises at least one additional line dedicated to the display, by property, of at least one conceivable setpoint that can be activated/inactivated as an alternative to the target setpoint being currently executed to attain/maintain a same target state of the aircraft,

According to a fourth option in addition to, or independent of, the three previous options, the line dedicated to the display, by property, of at least one next setpoint manually entered for execution from the current state of the aircraft, comprises at least one field dedicated to the display of at least one pre-selection setpoint, that can be activated/inactivated, from the current state of the aircraft and from the classified and analyzed data,

According to a fifth option in addition to, or independent of, the three previous options and/or in which the user interface matrix further comprises at least one additional field dedicated to the display, by property, of at least one next setpoint, to be activated, is automatically suggested to said crew member by said device in order to put the aircraft in a state compatible with the attainment of the setpoint previously informed by the pilot.

According to an optional variant, from the current state of the aircraft and the classified and analyzed data, the device 12 is further configured to determine and display via the complementary module 26, by property, in the line or lines dedicated to the display of said at least one next setpoint, a predicted result related to said next setpoint (entered by the user or suggested automatically) and/or an information representative of a reason for activation/deactivation of said next setpoint.

As an optional complement, from the current state of the aircraft and the classified and analyzed data, the device 12 is further configured to determine and display via the complementary module 26, per property:
a list of respectively related setpoint measurement units, and/or
at least one setpoint limit value in the line dedicated to displaying by property said at least one next setpoint manually entered for execution from the current state of the aircraft 10.

In the example of FIG. 1, the avionics device 12 for assisting in the control of at least one of the automated systems A₁, A₂, A₃, . . . , Aᵢ, . . . A_{N} of the aircraft 10 comprises an information processing unit 28, formed, for example, by a memory 30 related to a processor 32 such as a CPU-type processor (Central Processing Unit).

In the example of FIG. 1, the module 16 configured to classify and analyze the collected data, the module 18 configured to determine, from the classified and analyzed data and from a current state of the aircraft, whether an avionics setpoint, manually entered within said device, can be attained by means of said at least one automated system, and optionally, the complementary abstraction module 20, or even the complementary module 22 configured to provide a crew member with an indication representative of the possible or impossible attainment of the setpoint and/or, in the presence of an attainable setpoint, configured to determine and provide the crew member with at least one instruction to attain the setpoint, said at least one instruction to be transmitted to the automated system, or the complementary module 24 configured to build a universal user interface matrix, or even the complementary module 26 able to configure the display of such a matrix, are each realized in the form of a software executable by the processor 32.

The memory 30 of the information processing unit 28 is then able to store a first software configured to classify and analyze the collected data, a second software configured to determine, from the classified and analyzed data and from a current state of the aircraft, whether an avionics setpoint, entered manually within said device, can be attained by means of said at least one automated system, optionally a third software for abstraction, a fourth software configured to provide a crew member with an indication representative of the possible or impossible attainment of the setpoint, and/or, in the presence of an attainable setpoint, configured to determine and provide the crew member with at least one instruction for attaining the setpoint, said at least one instruction to be transmitted to the automated system, a fifth software configured to build a universal user interface matrix, and a sixth software able to configure the display of such a matrix.

The processor 32 is then able to execute the above-mentioned software.

In a variant not shown, the module 16 configured to classify and analyze the collected data, the module 18 configured to determine, from the classified and analyzed data and from a current state of the aircraft, whether an avionics setpoint, manually entered within said device can be attained by means of said at least one automated system, and optionally, the complementary abstraction module 20, or even the complementary module 22 configured to provide a crew member with an indication representative of the possible or impossible attainment of the setpoint, and/or, in the presence of an attainable setpoint, configured to determine and provide the crew member with at least one instruction to attain the setpoint, said at least one instruction to be transmitted to the automated system, or the complementary module 24 configured to build a universal user interface matrix or the complementary module 26, able to configure the display of such a matrix, are each realized in the form of a programmable logic component, such as an FPGA (Field Programmable Gate Array), or in the form of a dedicated integrated circuit, such as an ASIC (Application Specific Integrated Circuit).

When at least part of the avionics device 12 for assisting in the control of at least one of the automated systems A₁, A₂, A₃, . . . , Aᵢ, . . . A_{N} of the aircraft 10 is realized in the form of one or more software programs, in other words in the form of a computer program, it is furthermore able to be recorded on a computer-readable medium, not shown. The computer-readable medium is, for example, a medium able to store electronic instructions and of being connected to a bus of a computer system. For example, the readable medium is an optical disk, a magneto-optical disk, a ROM memory, a RAM memory, any type of non-volatile memory (for example, EPROM, EEPROM, FLASH, NVRAM), a magnetic card or an optical card. On the readable medium is then stored a computer program comprising software instructions.

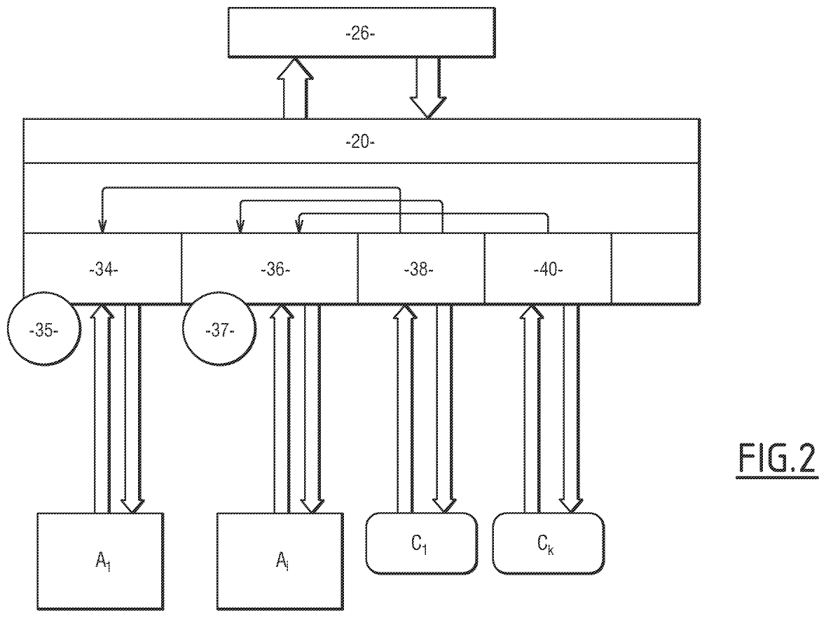

FIG. 2 illustrates the interactions between the control assistance avionics device 12, a plurality of automated aircraft systems, a plurality of contributors, and the aircraft crew.

According to the present invention, the management and control of at least one of the automated systems A₁, A₂, A₃, . . . , Aᵢ, . . . A_{N} is specifically at a different level of abstraction than the conventional control of such automated systems A₁, A₂, A₃, . . . , Aᵢ, . . . A_{N}.

Indeed, the conventional control of such automated systems A₁, A₂, A₃, . . . , Aᵢ, . . . A_{N} via a human-machine interface (HMI), devoid or almost devoid of logic processing for adapting the management to the needs of the user, generally consists in a simple display of values or states of the automated system considered by directly “passing-through” between this automated system and the user. The same is true for the requests sent to the automated system considered, by the user from the input means (that is, interactors such as buttons, rotators, . . . ) of the existing HMI human-machine interfaces shown in a similar way to the related technical capacity, which requires a heavy learning curve by the users.

In contrast, according to the present invention, the abstraction module 20 constitutes the connection of the multiple inputs and outputs to the HMI of the display configuration module 26 by freeing itself from the complexity implemented within each automated system. As illustrated in FIG. 2, such an abstraction module 20 is configured to support all compositional processing between the inputs/outputs of the device 12 (not shown in this FIG. 2 but comprising the abstraction module 20).

More specifically, as illustrated in FIG. 2, the abstraction module 20 comprises a plurality of input/output tools 34, 36, 38, and 40 adapting the inputs/outputs with, as illustrated, the automated system A₁, the automated system Aᵢ, a contributor C₁, and a contributor Cₖ. By “contributor” is meant any avionics source and/or any non-avionics source of data collected by the collection module 14; not shown in FIG. 2, the avionics and/or non-avionics source being distinct from the automated system considered and may correspond to a secure system of the aircraft 10 distinct from the automated system considered or to a less secure source (that is, integrated) than an avionics system such as a non-avionics source from the “outside world”, corresponding to a non-avionics calculator or to a supplier of observation data and information propositions (such as, suggestions) coming from algorithms executed outside the aircraft (for example, on the ground), such a non-avionics source being connectable to the device 12 via a non-avionics network, not shown, or via a dedicated link, not shown.

The consideration of non-avionics contributors is not disclosed or suggested by US 2017/291691 A1.

More specifically, the tool 34 of the abstraction module 20 is able to implement a predetermined ad hoc adaptation (such as, data conversion) of the input/output data related specifically to the automated system A₁ according to a predetermined configuration 35 specific to the automated system A₁, corresponding to the definition of inputs and outputs, data types, units, usage domain (such as, boundaries), data validities.

Similarly, the tool 36 of the abstraction module 20 is able to implement a predetermined ad hoc adaptation (such as, data conversion) of the input/output data related specifically to the automated system Aᵢ according to a predetermined configuration 37 specific to the automated system Aᵢ.

The tool 38 of the abstraction module 20 is able to implement a predetermined ad hoc adaptation (that is, data conversion) of the input/output data specifically related to the contributor C₁ and to transmit, in addition, at least one data item showing this adaptation to the tools 34 and 36. In other words, the processing implemented respectively by the tool 34 and by the tool 36 is able to take into account additional adaptation data supplied by the tool 38.

Similarly, the tool 40 is able to implement a predetermined ad hoc adaptation (that is, data conversion) of the input/output data specifically related to the contributor Cₖ and to transmit, in addition, at least one data item representative of this adaptation to the tool 36 related to the automated system Aᵢ.

In other words, the adaptation tools 34, 36, 38 and 40 of the abstraction module 20 and the predetermined internal exchanges according to an ad hoc operation between these tools within the abstraction module 20 make it possible to classify and analyze the collected data of the automated system A₁, the automated system Aᵢ, a contributor C₁, and a contributor Cₖ by transforming (that is, converting) at least one collected data into a standardized (that is, universal) data independent of the type of said at least one automated system or the type of source (for example, contributor) in order to provide the HMI (that is, the pilot control interface) of the display configuration module 26 with the current modes and states of the automated systems considered, independently of the type of automated system used. In other words, the abstraction module makes it possible, for an identical flight context, to provide the HMI of the display configuration module 26, according to the upward arrow between the abstraction module 20 and the HMI of the display configuration module 26, with the same information as the automated system A₁, corresponding to an autopilot, that is, the one specific to an Airbus A330 or to an Airbus A380.

Conversely, the tools 34, 36, 38 and 40 for adapting the abstraction module 20 and the predetermined internal exchanges according to an ad hoc operation between these tools within the abstraction module 20 make it possible, according to the downward arrow of the HMI of the display configuration module 26, to the abstraction module 20, to transform a setpoint entered manually within said device 12 into at least one order adapted to the type of said at least one automated system, the setpoint being, for example, identical for the user, especially a pilot, whether the automated system A₁, corresponding to an autopilot, is that specific to an Airbus A330 or to an Airbus A380.

Thus, the abstraction module 20 is able to implement an adaptation between the multiple functional capabilities of an automated system and a virtual control HMI interface, for example a Virtual Auto Pilot Control Panel (VAPCP), of the display configuration module 26. Such an abstraction module 20 allows to synthesize the capabilities of each automated system to which it is related, to merge predetermined sub-functions as a function of the automated system considered and to automate processes also predetermined as a function of the automated system considered, while matching the available possibilities in the control interface with the available commands of any automated system type considered, for example, for any type of autopilot. This “adaptation” between the technical capacity of an automated system and the real needs of a human consists in controlling the automated system considered, not with a multitude of buttons to activate this or that functionality specific to a particular automated system, but rather with an intuitive interface adapted to the will and operational needs of the user.

The operation of the abstraction module 20 is further described in relation to the following, FIGS. 3 to 7.

FIGS. 3 and 4 illustrate different parts and variants of an example of a universal user interface matrix built according to a particular aspect of the present invention by the module 24 for, for example, the automated system A₁ corresponding to an autopilot. Such a construction module 24 is, especially, able to receive the same information determined by the abstraction module 20 as that transmitted to the display configuration module 26, or in an unrepresented manner, is able to receive the information from the abstraction module 20 instead of from the display configuration module 26, in order to build the universal user interface matrix transmitted to the display configuration module 26 which subsequently displays it.

For the automated system A₁ corresponding to an autopilot, such a universal user interface matrix of any type of autopilot comprises, for example, two parts 42 and 44 able to be displayed one below the other, vertically, as shown in FIG. 3, or not shown, one next to the other horizontally.

The part 42 restores the characteristics related to two properties P₁ and P₂ of the autopilot, the property P₁ corresponding to the longitudinal speed axis of movement of the aircraft 10 and the property P₂ corresponding to the lateral axis of movement of the aircraft 10.

The part 44 restores the characteristics related to two other properties P₃ and P₄ of the autopilot, related to the vertical displacement of the aircraft, the property P₃ corresponding to the displacement altitude of the aircraft 10 and the property P₄ corresponding to the vertical displacement speed of the aircraft 10.

As illustrated in FIGS. 3 and 4, such a matrix comprises for example, here, for each property three lines, an upper line, a middle line and a lower line.

According to a particular aspect of the invention, the middle line comprises, for each property, fields dedicated to the display of the current target setpoints that the automated system A₁, corresponding to an autopilot, is following.

Alternatively, or cumulatively, such target setpoints are able to be displayed later by the display configuration module 26 with a dedicated color distinct from that used for the other setpoints and/or the other lines, which makes it easier for the user to understand.

For example, in FIG. 3, the automated system A₁ corresponding to an autopilot is in the process of applying a property P₁ of longitudinal speed of 271 kt, a property P₂ corresponding to a navigation heading HDG of 022° towards a navigation point named DENUT with a property P₃ of constrained altitude of 2400 ft towards the navigation point DENUT towards which the flight plan management system FMS is navigating vertically.

According to a particular aspect, the constructor module 24 and/or the display configuration module 26 are able to add indicators corresponding to visual display artifacts to indicate whether the target setpoint is being acquired (that is, a state of progress of the aircraft towards the target setpoint), for example with brackets as shown in FIG. 3, or whether the target setpoint is acquired and the autopilot is maintaining the aircraft 10 on target which is the case for the 2400 ft altitude shown partially boxed.

In other words, for this example of application to the automated system A₁ corresponding to an autopilot, the universal user interface matrix allows a simplification of the representation of what the automated system, corresponding here to an autopilot, does, by abstracting the internal processing of this automated system by forgetting the notion of mode to concentrate on the notion of target or objective, which can then be either in the process of being acquired or acquired and held.

Moreover, according to the present invention, such a matrix specific to the automated system A₁ corresponding to the autopilot, via the abstraction module 20, is able to integrate information from another automated system distinct from the autopilot considered, namely the automated system A₂ corresponding to the flight management system or FMS. Such an integration is specifically implemented according to the present invention where previously some information was accessible in the autopilot management equipment and other information was only available on the avionics head down displays.

In addition, the user interface matrix illustrated in FIG. 3 comprises an upper line the fields of which are dedicated to displaying, by property, possible alternative setpoints in the application of the tactical plan of aircraft 10, based on the current state of the aircraft and the classified and analyzed data. Such possible alternative setpoints are provided by “trusted” contributors located within the avionics equipment of the aircraft.

As an alternative, the line dedicated to the display, by property, of possible alternative setpoints is a line of the matrix distinct from the one dedicated to the target setpoints being currently executed and not necessarily the upper line as illustrated by FIG. 3 above.

Thus, in the example of FIG. 3, the user can activate the automatic management of the longitudinal speed P₁, which would initially make the aircraft 10 accelerate to 280 kt, because of a constraint on the navigation point DENUT, activate, for the lateral displacement property P₂, the management of the automatic navigation, making the aircraft initially pass by the navigation point DENUT.

In the same way, in the upper line of the vertical part 44, in which it is possible to display the possible alternative setpoints, especially in terms of vertical speed, LVL OFF meaning that it is possible to cancel the vertical speed, or in terms of altitude, in this case the VNAV (24000 ft) DENUT is, for example, automatically deactivated, due to the current context, that is, here, for example, the fact that one is not in LNAV, this explanation (that is, the causal link explaining the deactivation) being able optionally to also be displayed. Such a deactivation is displayed by means of a deactivation color, for example, grayed out via the display configuration module 26.

According to a particular aspect, this upper line (or another line of the matrix distinct from the one dedicated to the target setpoints being currently executed) comprises a field dedicated to displaying the reason for deactivation of an unable to be activated setpoint from the current state of the aircraft 10.

According to the present invention, the determination and accessibility of these possible alternative setpoints is managed either directly by the automated system, if it has this capability, or by the abstraction module 20 by completing the specific configuration 35 related to the automated system A₁ or by a predetermined ad hoc processing implemented by the tool 34 of FIG. 2, such processing being able to propose complementary tactical alternatives, such as the provision of an avionics command for the output of a “holding pattern” conventionally made available by the interface related to the flight plan management system FMS and not by the one related to the autopilot via the abstraction module 20 proposed, according to the present invention. The tactical scope of this command, its necessarily immediate consideration and its semantic and operational proximity to the autopilot make it relevant for integration within the processing implemented by the tool 34 of the abstraction module 20.

Moreover, the user interface matrix illustrated in FIG. 3 comprises a lower line whose fields are dedicated to the display of at least one next setpoint manually entered for execution from the current state.

Alternatively, the line dedicated to the display, by property, of at least one next setpoint manually entered for execution from the current state is a line of the matrix distinct from the one dedicated to the target setpoints being currently executed or from the one dedicated to the possible alternative setpoints and not necessarily the lower line as illustrated by FIG. 3 above.

More precisely, a “target setpoint” is related to a first state of the aircraft 10 to be attained or maintained, while a “next setpoint” is related to a second state of the aircraft to be attained after the first state.

In other words, the matrix presents a reserved space for control by the pilot who has at their disposal fields allowing them to intervene manually, directly and efficiently on each of the properties of the automated system considered to which the universal user interface matrix is related.

For example, in the case where the automated system is in the process of acquiring a target setpoint on an axis, the user (the pilot) thus has the capacity to interrupt at any moment (by pressing on a physical control means or by a secure interaction (for example a predetermined gesture) the behavior of the automated system considered which will, as far as possible, stabilize the aircraft on the current property, namely the current value of the axis considered.

Moreover, this reserved space for control by the pilot is configured to allow the setting/entering in advance of a next target setpoint, especially on the recommendation of the ATC (Air Traffic Control). Advantageously, such a next target setpoint is displayable as a pre-selection, able to be activated by pressing a physical control means or by a secure interaction.

Thus, according to this aspect, the present invention proposes to systematize the use of a pre-selection, and this for each property of the automated system by offering the user the possibility to prepare in advance a next setpoint and to be able to easily engage it when needed:

Such an aspect implies the need to validate the next target setpoint before it is actually taken into account by the automated system considered, in order to secure its activation and due to the fact that this aspect is systematized for all the properties, which allows to rapidly develop the capabilities of the automated systems thus controlled by means of the device 12 according to the present invention.

Advantageously, such an aspect offers the ability to anticipate, in other words, to prepare a preselection, and then to activate it at the appropriate time, and the ability to preview what the automated system will do if the next new target setpoint is explicitly engaged. Indeed, the dynamic preparation without immediate engagement of a trajectory allows to judiciously refine it and to intuitively understand what will happen at the engagement, and to avoid unpleasant surprises related to a non-anticipated behavior of the considered automated system.

Moreover, according to an optional complementary aspect, the fields, dedicated to the display of at least one next setpoint manually entered for execution from the current state, created by the module 24 configured to build the interface matrix, are reconfigurable in terms of setpoint unit(s) and/or in terms of setpoint mode, which allows to apply, a change of mode/unit only to the preselection of the pilot (in other words, to the next setpoint entered by the pilot before its effective activation), and not by the current target setpoint, the main interest is to avoid surprises during these mode/unit changes by pre-viewing the potential next target.

The device 12 according to the present invention thus makes it possible to gather (or even unify and simplify) in a universal user interface matrix all the relevant information for controlling the autopilot and allowing to understand the behavior of the aircraft, as well as the possible alternatives.

Thus, the present invention proposes to abstract the common modes specific to each type of automated system, for example the target capture modes, to stick to the sole distinction “being acquired” or “acquired”, possibly specifying the way of acquiring the target if this has an operational meaning, for example on the acquisition of a heading, the direction of turn could also be specified according to the present invention).

Moreover, such a universal user interface matrix is homogeneous and allows a complete unification of all the control means of the automated system related to the matrix, to quickly and efficiently acquire a perception of all the properties of the automated system (no sub-page, no refinement essential to the understanding), and the contextual taking into account of the capacities and constraints on the various properties of the automated system.

Thus, the device 12, according to the present invention, is capable of integrating, analyzing, showing, suggesting and manipulating alternative proposals of target values for the various properties of the automated system considered, in order to put the device in a state compatible with the attainment of the setpoint previously informed by the pilot.

FIG. 4 illustrates variants of FIG. 3 showing an example of a universal user interface matrix according to the present invention. In particular, the parts 46 and 48 are two distinct variants of part 44 restoring the property P₃ of the autopilot corresponding to the displacement altitude of the aircraft 10 and the property P₄ corresponding to the vertical displacement speed of the aircraft 10.

These two parts 46 and 48 make it possible to illustrate an unambiguous backup provided to the pilot by the device 12 according to the invention via the complementary module 24 configured to build a universal user interface matrix, and the complementary module 26 able to configure the display of such a matrix, which restore a logic of organization of the possible alternative setpoints in a single and complete interface and make it possible to indicate to the pilot existing links between the properties of the automated systems of the aircraft, and therefore, at the same time, by explaining precisely, especially the order of the related actions to be followed to attain a desired target, or even by pointing out, if necessary, the inconsistencies between these related properties, for example, in two steps, by indicating during editing the inconsistencies to be solved, then by rejecting the inconsistent entered setpoints, while highlighting the blocking parameter(s), to be corrected for a correct consideration. This is the case, for example, between an altitude setpoint and a rate of climb: if the rate of climb is positive, the next target altitude must necessarily be above the current altitude.

On the part 46 of FIG. 4, the current target setpoint on the middle line is a hold at the acquired altitude of 19800 ft, as restored especially by means of a complete framing of this value of 19800 ft, and for example furthermore restored by means of a specific color, specific to the current target setpoint, for example in pink, the upper line indicates an altitude constraint of 24000 ft on the target navigation point DENUT (the aircraft 10 having to be precisely at this altitude on this point, by published procedure or air traffic control setpoint) and is restored in white, and the lower line dedicated to the input of a next setpoint indicates that the setpoint entered in advance by the pilot before activation is 22000 ft with a negative FPA (Flight Path Angle) rate of climb of −0.8° which is inconsistent with an increase in the current altitude from 19800 ft to 22000 ft. Such a lower line comprising an inconsistency for example detected by the complementary module 24 configured to build a universal user interface matrix, and/or by the complementary module 26 able to configure the display of such a matrix would then be, for example, restored with a color dedicated to inconsistency restoration for example orange.

In a way, not represented, with the same unambiguous backup logic, the complementary module 24 configured to build a universal user interface matrix is, according to a particular aspect, able to indicate the limits accessible by the aircraft. For example, for the automated flight control system, in its current context, given the current speed and engine reserve, the climb capability of the aircraft is a maximum of 6.5° and any higher request cannot be accepted, or given the weight (fuel) of the aircraft, the attainable altitude ceiling is able to be displayed in a dedicated field within the matrix with, if necessary, a related climb assistance setpoint to attain it.

Similarly, it is common in aircraft operations to “second” (in other words, to ensure) the vertical behavior of the FMS by setting an altitude ceiling and/or floor altitude that the aircraft will not cross “on its own” without pilot intervention, and according to a particular aspect, the complementary module 24 configured to build a universal user interface matrix and/or the complementary module 26 able to configure the display of such a matrix are advantageously able to signal to the pilot any inconsistency between this ceiling/floor and the behavior of the vertical flight management system, while preventing activation of such inconsistencies. For example, the building module 24 is able to detect an inconsistency between this ceiling/floor value and the behavior of the vertical flight management system and to continuously transmit its detection result to the display configuration module 26 which, in the presence of inconsistency, selects the predetermined display color dedicated to alerting on the presence of inconsistency, such as orange.

In part 48 of FIG. 4, according to a particular aspect, the building module 24 of the universal user interface matrix is further configured to integrate within this matrix at least one additional line dedicated, or at least one additional field dedicated, to the display by property of at least one next setpoint, to be activated, and suggested automatically to said crew member by said device. Such a suggested setpoint comes from services and contributors, especially non-avionics, of the “open world”, distinct from “trusted” contributors able to provide, by anticipation, the aforementioned possible alternative setpoints in order to put the aircraft into a state compatible with the attainment of the setpoint previously given by the pilot. In other words, according to this optional aspect, the building module 24 of the universal user interface matrix allows to clearly differentiate the suggestions from the non-avionics open world by relating them to a dedicated line/field, so that they are not applied blindly, but after a conscious validation by the pilots.

For example, when the user is going to request the attainment of a target flight altitude (that is, manually enter a target flight altitude command), which is out of the domain currently possible given the current state of the aircraft, then, according to this particular aspect, the device 12 is configured to suggest, via the user interface matrix and from the avionics and/or non-avionics data collected beforehand, the adoption of a different speed or a reduction of the current turn in order to put the aircraft in condition to reach this target altitude according to the set of flight parameters and the capabilities of the aircraft.

Such an aspect makes it possible to suggest to the pilot what he “could do”, in other words what should be activated in the automated system considered according to a preselected strategy elsewhere, examples of suggestions are described especially in patent FR 3 046 225 in the name of the Applicant, which relates to a display of meteorological data in an aircraft and not to the assistance in the control of an automated system such as referred to according to the present invention incorporating such suggestions.

In part 48 of FIG. 4 a suggestion on the 8000 ft vertical axis is provided to the pilot automatically by means of the building module 24 and the display configuration module 26 of the device 12, so as to be directly evaluated, and possibly activated by the pilot, without having to make any manual input, in other words without the pilot having to mentally determine it.

In other words, such an aspect allows the integration of these suggestions to be effectively taken into account by the pilot and possible activation by the same principles of secured interactions (gesture) as quoted previously.

It is thus conceived that, according to this aspect, the avionics device 12 for assisting the control of at least one of the automated systems A₁, A₂, A₃, . . . , Aᵢ, . . . A_{N} of the aircraft 10 allows the integration (that is, the grouping) in a single interface of all the relevant elements pertaining to the management of the tactical behavior of the aircraft and coming from different sources, in connection with the considered automated system, for example the autopilot A₁, in order to have a complete and coherent perception of it. The raster representation of the autopilot A₁ interface of each property, is able to include, as previously described a level (or a line or a dedicated display field) for the current state, a level (or a line or a dedicated display field) for the representation of the avionics suggestions (alternatives), a level (or a line or a dedicated display field) for the “free” expression of the pilot, one or n possible levels for suggestions coming from other less secured sources for example from the “world outside” the aircraft.

Such an aspect also allows the systematization of the use of a preselection for all the properties/axes of the automated system considered, the direct interaction on this same interface to activate a suggested or manually entered target, the representation of dynamic links between the properties of the automated system considered, while being applicable/derivable to any automated system of an aircraft.

The aim, here, is to streamline the monitoring and control interface of an automated system, such as an autopilot for example, with the object of simplifying the handling, understanding and decision making related to the tactical behavior of the aircraft 10.

FIGS. 5 to 7 illustrate different examples of exchanges able to be implemented by the control assistance avionics device according to the present invention and allow the operation of the abstraction module 20 to be specified.

The data manipulated by the automated systems A₁, A₂, A₃, . . . , Aᵢ, . . . A_{N} of the aircraft 10 generally correspond to an operational meaning such as the heading, to a domain or a range of use or variation of the setpoint such as a range [0-359], or even [−179 to 180] for example to indicate a setpoint in degrees, to a unit such as degrees or radians, feet, meters, etc., to a relative control mode such as incremental or decremental+1/−1, absolute positioning, relative positioning, etc., to particularities such as the use of the direction of rotation indicating the direction of turn, etc., these definitions varying from one automated system to another.

The objective of the abstraction module 20 proposed, according to the present invention, is to disregard the definitions specific to each automated system, to propose a common definition and capabilities, regardless of the aircraft (that is, the carrier).

Such an abstraction module is composed of multiple ad hoc algorithms depending on the data, modes, capabilities, and constraints of the automated systems.

Thus, according to the example of FIG. 5, the automated system A₁ corresponding to an autopilot of a first type transmits a mode 50, for example Aᵢ to the tool 34 of the abstraction module 20 which translates it into a state 52 of ascent implemented by the automated system A₁ and the abstraction module informs the display configuration module 26 that it is necessary to display the value 54 “ascent” in the dedicated field of the universal user interface matrix.

The automated system Aⱼ corresponding to an autopilot of a second type, distinct from the autopilot type A₁ transmits a mode 56, for example a to the tool 34 of the abstraction module 20 which also translates it into a state 58 of ascent implemented by the automated system Aⱼ and the abstraction module informs the display configuration module 26 that the value 60 “ascent” should be displayed in the dedicated field of the universal user interface matrix.

In other words, according to the present invention, two modes A and a delivered by two autopilots of different types, respectively A₁ and Aⱼ lead to the display for the pilot of the same “ascent” mode (this view is all theoretical since the automated systems A₁ and Aⱼ are generally exclusive on the same aircraft). Thus, in the event of a change in the type of automated system on an aircraft, the pilot does not have to be trained again since the abstraction module 20 makes it possible to get rid of the particularities of each type of automated system.

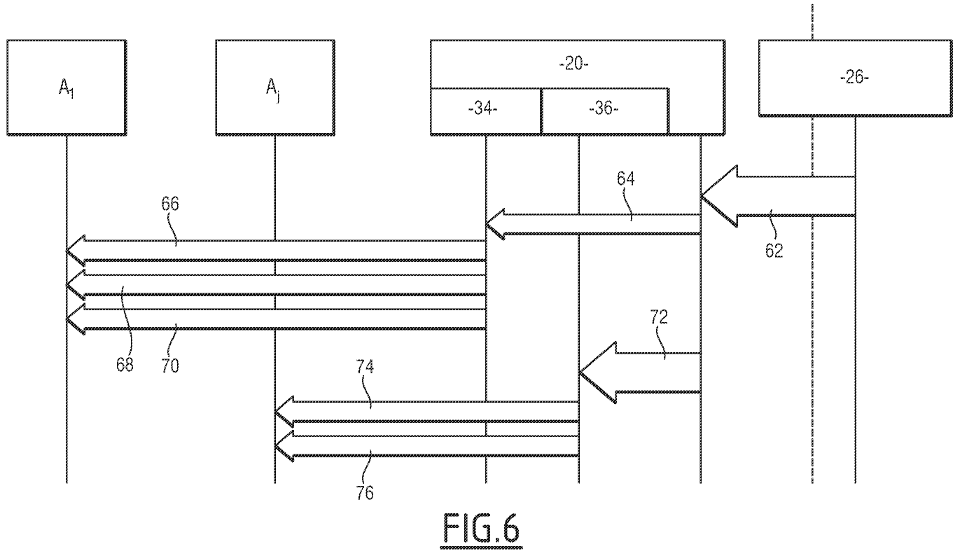

Conversely, in another case of use as illustrated by FIG. 6, a pilot interaction 62 is able to be transmitted differently via the abstraction module 20 to the automated systems according to their properties. According to the arrow 64, this interaction 62 corresponding, for example, to a 120° heading instruction and to a left turn instruction is transmitted to the conversion tool 34 of the abstraction module 20 dedicated to the automated system A₁ corresponding to an autopilot A₁ of a first type, which transforms it into decremental heading instructions intended for the autopilot A₁ of the first type, so that, starting from the current heading, the 120° heading is attained by means of a plurality of decreases 66, 68, 70 of 1° value, and according to the arrow 64 this interaction 62 corresponding for example to a 120° heading instruction and to a left turn instruction is transmitted to the conversion tool 36 of the abstraction module 20 dedicated to the automated system Aⱼ corresponding to an autopilot A₁ of a second type which transforms it into two distinct instructions 74 and 76 of left turn and 120° heading respectively.

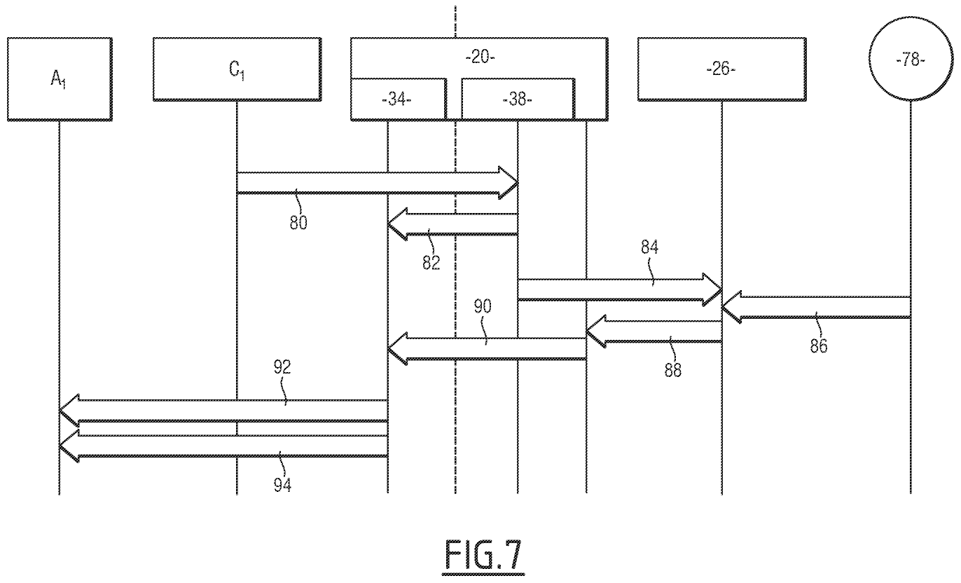

FIG. 7 illustrates the suggestion to the pilot 78 of a mode or target data coming from a contributor C₁ such as a fuel consumption optimization service able to suggest a new flight level (reducing fuel consumption, while being relevant given the current weight of the aircraft). According to this example, the contributor C₁ determines a suggestion 80, for example an altitude value, and transmits it to the tool 38 of the abstraction module 20 dedicated to the contributor C₁, which checks, as represented by the arrow 82, with the conversion tool 34 of the abstraction module 20 dedicated to the automated system A₁, whether such a suggestion can be implemented, such a suggestion being able to put the apparatus (that is, the aircraft) into a state compatible with the attainment of the setpoint previously entered by the pilot. If so, as illustrated in FIG. 7, the abstraction module tool 38 transmits, as illustrated by arrow 84, this suggestion for display to the display configuration module 26. According to the arrow 86, the pilot 78 accepts such a suggestion. According to the arrow 88, the display configuration module 26 transmits the activation request 88, entered via its interface, to the abstraction module 20 which redirects it according to the arrow 90 to the conversion tool 34 of the abstraction module 20 dedicated to the automated system A₁. Then, the conversion tool 34 of the abstraction module 20 dedicated to the automated system A₁ translates it into two instructions allowing to attain such a setpoint, namely an ascent instruction 92 and a target altitude instruction originally suggested automatically by the contributor C₁.

Thus, the abstraction module 20 according to the present invention makes it possible to abstract, as seen by the user, both the contributor C₁ (and its suggestion mode) and the type of automated system for which this suggestion is ultimately intended.

The operation of the avionics device 12 for assisting the control of at least one of the automated systems A₁, A₂, A₃, . . . , Aᵢ, . . . A_{N} of the aircraft 10 will now be described.

According to a first main step of the method for assisting the control of at least one automated aircraft system implemented by such an avionics device 12 connectable, via an avionics network, to said at least one automated system and to a plurality of avionics sources, and/or via a non-avionics network to a plurality of non-avionics sources, distinct from the automated system, the avionics device 12, via the collection module 14, collects avionics and/or non-avionics data supplied by the plurality of sources and supplied by said at least one automated system.

According to a second main step of the method for assisting the control of at least one automated aircraft system, such an avionics device 12 implements, via the second module 16, a classification and analysis of the collected data as a function of each predetermined property to be restored from said at least one automated system.

According to a third main step of the method for assisting the control of at least one automated aircraft system, such an avionics device 12 implements, via the module 18, a determination, from the classified and analyzed data and from a current state of the aircraft, of the chances of attaining an avionics setpoint by means of said at least one automated system.

It is to be noted that in a complementary and optional manner such a method comprises additional complementary and optional steps corresponding to the complementary and optional modules/tools/aspects described above with respect to the avionics device 12, such as, especially, an abstraction step implemented by the previously described abstraction module 20 allowing to adapt/convert each input received by the abstraction module 20 from automated systems, from contributor, into a universal output independent of the type of automated system or the type of contributor and allowing conversely to adapt/convert any universal input entered by a crew member into an output adapted (that is, a command) to the type of automated system for which the universal input is intended.

Similarly, such a method comprises a step of building and a step of displaying a universal user interface matrix implemented by the complementary modules 24 and 26 respectively.

It is thus conceivable that the avionics device 12, like the method for assisting in the control of at least one related automated aircraft system, allows for a simplification of the control of an automated aircraft system, especially in terms of perception of its operating state and in terms of designation of setpoints, since the type of automated system implemented or even the type of aircraft (that is, carrier) is not required. Decision-making and commanding such automated systems controlled by means of the device 12 and the method according to the present invention is consequently facilitated.

Indeed, the understanding of what the automated system does, the understanding of what the automated system will do without pilot action, the transmission of setpoints to the automated system by the pilots and the understanding of the potential of the automated system in the current context are simplified according to the present invention and allow a better anticipation of the consequence related to the setpoint manually entered by the user.

Moreover, the avionics device 12, as well as the method for assisting the control of at least one related aircraft automated system, allow the perception of the alternatives (that is, suggestion) offered to the pilots with respect to these different setpoints, to homogenize the management of the control of the automated system regardless of the control mode used, to translate a technical capability potential of an automated system to adapt it to a graphical control interface.

Compared to the patent application US 2017/291691 A1, which aims to adapt/restrict, upstream of the setpoint input by a pilot, the range of setpoints able to be selected, as a function of the current flight context, the present invention is implemented downstream of the setpoint input by a pilot and aims to determine, from collected avionics and/or non-avionics data, whether or not this setpoint is still attainable after entry in order to better anticipate the behavior of the aircraft, or even to suggest to the pilot additional actions and/or setpoints to be entered in order to attain the setpoint already entered manually.

1. An avionics device for assisting the control of at least one automated system of an aircraft, the device being connectable, via an avionics network, to said at least one automated system and to a plurality of avionics sources, and/or via a non-avionics network to a plurality of non-avionics sources, distinct from the automated system
wherein said device is configured for:
collecting avionics and/or non-avionics data provided by the plurality of sources and provided by said at least one automated system,
classifying and analyzing the collected data as a function of each predetermined property to be restored by said at least one automated system,
determining, from the classified and analyzed data and from a current state of the aircraft, whether an avionics setpoint, manually entered within said device, can be attained by means of said at least one automated system.

2. The device according to claim 1, wherein the device is configured to:
classify and analyze collected data by transforming at least one collected data into a standardized data independent of the type of said at least one automated system or the type of source, and/or
transform a manually entered setpoint within said device into at least one order adapted to the type of said at least one automated system.

3. The device according to claim 1, wherein the device is further configured to:
provide an indication to a crew member representative of whether the setpoint is attainable or not, and/or
in the presence of an attainable setpoint, determining and providing to the crew member at least one instruction to attain the setpoint, said at least one instruction to be transmitted to the automated system.

4. The device according to claim 3, wherein the device is configured to build and display a universal user interface matrix, independent of the type of said at least one automated system or the type of source, the user interface matrix comprising at least two lines and at least as many columns as predetermined properties to be restored of said at least one automated system,
said at least two lines being respectively dedicated to the display by property:
of at least one target setpoint being currently executed by the automated system of the aircraft,
at least one next setpoint manually entered for execution from the current state of the aircraft.

5. The device according to claim 4, wherein the device is configured to display the target setpoint using two distinct indicators related respectively, to a state of acquisition and maintenance of the target setpoint by the automated system, and to a state of progress of the aircraft, via the automated system, towards the target setpoint.

6. The device according to claim 4, wherein the device is configured to display the line dedicated to displaying said at least one target setpoint being currently executed by the automated system of the aircraft, in the center of the user interface matrix and/or with a dedicated color distinct from the display color of the other lines of the user interface matrix.

7. The device according to claim 4, wherein the user interface matrix further comprises at least one additional line dedicated to the display by property, of at least one possible setpoint, able to be activated or not, alternative to the target setpoint being currently executed to attain/maintain a same target state of the aircraft,
and/or in which the line dedicated to the display, by property, of at least one next setpoint manually entered for execution from the current state of the aircraft comprises at least one field dedicated to the display of at least one pre-selection setpoint, able to be activated or not, from the current state of the aircraft and the classified and analyzed data,
and/or wherein the user interface matrix further comprises at least one additional line dedicated to the display by property of at least one next setpoint, to be activated, and automatically suggested to said crew member by said device.

8. The device according to claim 7, wherein, from the current state of the aircraft and the classified and analyzed data, the device is further configured to determine and display, by property, in the line(s) dedicated to displaying said at least one next setpoint, a predicted result related to said next setpoint and/or information representative of a reason for activation/deactivation of said next setpoint.

9. The device according to claim 4, wherein, from the current state of the aircraft and the classified and analyzed data, the device is further configured to determine and display, by property:
a list of respectively related setpoint measurement units, and/or
at least one setpoint limit value in the line dedicated to displaying by property said at least one next setpoint manually entered for execution from the current state of the aircraft.

10. Aircraft comprising at least one automated system, wherein the aircraft further comprises an avionics device for assisting the control of said at least one automated system according to claim 1.

11. The device according to claim 5, wherein the device is configured to display the line dedicated to displaying said at least one target setpoint being currently executed by the automated system of the aircraft, in the center of the user interface matrix and/or with a dedicated color distinct from the display color of the other lines of the user interface matrix.

12. The device according to claim 5, wherein the user interface matrix further comprises at least one additional line dedicated to the display by property, of at least one possible setpoint, able to be activated or not, alternative to the target setpoint being currently executed to attain/maintain a same target state of the aircraft,
and/or in which the line dedicated to the display, by property, of at least one next setpoint manually entered for execution from the current state of the aircraft comprises at least one field dedicated to the display of at least one pre-selection setpoint, able to be activated or not, from the current state of the aircraft and the classified and analyzed data,
and/or wherein the user interface matrix further comprises at least one additional line dedicated to the display by property of at least one next setpoint, to be activated, and automatically suggested to said crew member by said device.

13. The device according to claim 6, wherein the user interface matrix further comprises at least one additional line dedicated to the display by property, of at least one possible setpoint, able to be activated or not, alternative to the target setpoint being currently executed to attain/maintain a same target state of the aircraft,
and/or in which the line dedicated to the display, by property, of at least one next setpoint manually entered for execution from the current state of the aircraft comprises at least one field dedicated to the display of at least one pre-selection setpoint, able to be activated or not, from the current state of the aircraft and the classified and analyzed data,
and/or wherein the user interface matrix further comprises at least one additional line dedicated to the display by property of at least one next setpoint, to be activated, and automatically suggested to said crew member by said device.

14. The device according to claim 11, wherein the user interface matrix further comprises at least one additional line dedicated to the display by property, of at least one possible setpoint, able to be activated or not, alternative to the target setpoint being currently executed to attain/maintain a same target state of the aircraft,
and/or in which the line dedicated to the display, by property, of at least one next setpoint manually entered for execution from the current state of the aircraft comprises at least one field dedicated to the display of at least one pre-selection setpoint, able to be activated or not, from the current state of the aircraft and the classified and analyzed data,
and/or wherein the user interface matrix further comprises at least one additional line dedicated to the display by property of at least one next setpoint, to be activated, and automatically suggested to said crew member by said device.

15. The device according to claim 5, wherein, from the current state of the aircraft and the classified and analyzed data, the device is further configured to determine and display, by property:
a list of respectively related setpoint measurement units, and/or
at least one setpoint limit value in the line dedicated to displaying by property said at least one next setpoint manually entered for execution from the current state of the aircraft.

16. The device according to claim 6, wherein, from the current state of the aircraft and the classified and analyzed data, the device is further configured to determine and display, by property:
a list of respectively related setpoint measurement units, and/or
at least one setpoint limit value in the line dedicated to displaying by property said at least one next setpoint manually entered for execution from the current state of the aircraft.

17. The device according to claim 7, wherein, from the current state of the aircraft and the classified and analyzed data, the device is further configured to determine and display, by property:
a list of respectively related setpoint measurement units, and/or
at least one setpoint limit value in the line dedicated to displaying by property said at least one next setpoint manually entered for execution from the current state of the aircraft.

18. The device according to claim 8, wherein, from the current state of the aircraft and the classified and analyzed data, the device is further configured to determine and display, by property:
a list of respectively related setpoint measurement units, and/or
at least one setpoint limit value in the line dedicated to displaying by property said at least one next setpoint manually entered for execution from the current state of the aircraft.

19. Aircraft comprising at least one automated system, wherein the aircraft further comprises an avionics device for assisting the control of said at least one automated system according to claim 2.

20. Aircraft comprising at least one automated system, wherein the aircraft further comprises an avionics device for assisting the control of said at least one automated system according to claim 3.
